(19) United States
(12) Patent Application Publication
(10) Pub. No.: US 2008/0274717 A1
(43) Pub. Date: Nov. 6, 2008

(54) Apparatus of Transmitting Private Information in Mobile Terminal and Its Method

(75) Inventor: Jong Oh Kim, Seoul (KR)

Correspondence Address: RABIN & Berdo, PC, 1101 14TH STREET, NW, SUITE 500, WASHINGTON, DC, 20005, US

(73) Assignee: Eun Sang JUNG, Seoul (KR)

(21) Appl. No.: 12/091,606

(22) PCT Filed: Sep. 18, 2006
(86) PCT No.: PCT/KR06/03713

§ 371 Date: Apr. 25, 2008

(30) Foreign Application Priority Data
Oct. 27, 2005 (KR) 10-2005-0101828

(51) Int. Cl. H04M 1/66

(52) U.S. Cl. 455/411

(57) ABSTRACT

Disclosed is an apparatus and method of transmitting private information in a mobile terminal, which is capable of transmitting all data (for example, a telephone directory, moving pictures, photographs, memos, a call list, transmitted and received messages, bell sound, MP3 data, etc.) stored in a mobile terminal to another mobile terminal. The private information transfer apparatus for transferring data of a mobile terminal, includes: a mobile terminal interface through which the mobile terminal accesses the private information transfer apparatus; a mobile terminal recognizer that recognizes the accessing mobile terminal; an authentication processor connected to an external authentication server for processing an authentication for the private information transfer apparatus; a mobile terminal module receiver connected to an external mobile terminal module provision server for requesting and receiving a mobile terminal module of the mobile terminal when the accessing mobile terminal is recognized; a storage that stores the data of the accessing mobile terminal according to the received mobile terminal module and provides the stored data at request; a controller connected to the mobile terminal interface, the mobile terminal recognizer, the authentication processor, the mobile terminal module receiver, and the storage for controlling data transfer of the mobile terminal.

### TECHNICAL FIELD

The present invention relates to an apparatus and method of transmitting private information in a mobile terminal, and more particularly, to an apparatus and method of transmitting private information in a mobile terminal, which is capable of transmitting all data (for example, a telephone directory, moving pictures, photographs, memos, a call list, transmitted and received messages, bell sound, MP3 data, etc.) stored in a mobile terminal to another mobile terminal.

### BACKGROUND ART

Mobile terminals are necessities of modern life. Many people access a variety of information sources through their own mobile terminals. As mobile terminals have been ubiquitous and their service area has spread, their management issues have been made. In particular, when an old mobile terminal is replaced with a new one, there arises a problem of transfer of data stored in the old mobile terminal into the new one.

At present, with increase of data storage capacity of mobile terminals (for example, data storage capacity up to 2000 telephone numbers) and development of mobile terminal technology, the amount of data such as an address book, moving pictures, photographs, downloaded contents, etc., which are stored in the mobile terminals, is greatly increasing. In addition, as mobile terminal users tend to concentrate information or data on their mobile terminals, management of the information or data stored in the mobile terminals becomes more important.

With reduction of an average replacement cycle of mobile terminals, there is a need for transfer (restoration) of data from an old mobile terminal to a new one. However, it is under actual circumstances that programs provided by mobile terminal makers can not transfer the data (except address books (including names, telephone numbers, etc.)) stored in the old mobile terminal to the new one, except transfer of data to the same kind of mobile terminal (having the same model name). In general, users replace their old mobile terminals with new mobile terminals superior in performance to the old mobile terminals or with different mobile terminals manufactured by different companies. However, for the present, the users have no practical way to transfer data stored in the old mobile terminals to the new or different mobile terminals. This makes the user reluctant to purchase the new or different mobile terminals since it is troublesome for the users to newly register and store data from the old mobile terminals into the new or different mobile terminals.

To overcome the above problem and improve mobile terminal users' convenience, there is a need for a solution for defining data areas depending on the kind of mobile terminals and simultaneously transferring information or data of the defined data areas.

In addition, with diversification of kinds of mobile terminals, different mobile terminals have different resolutions supported for photographs and the different number of bell sound sources. In this case, although data are transferred from an old mobile terminal to a new one, the new mobile terminal may not use the transferred data. Accordingly, there is also a need for a solution to this problem.

### DISCLOSURE OF INVENTION

### Technical Problem

It is therefore an object of the present invention to provide an apparatus and method of transmitting private information in a mobile terminal, which is capable of receiving first data from an old mobile terminal when being requested to do so, converting the received first data into second data of a format adapted to a new mobile terminal, and transmitting the second data to the new mobile terminal.

It is another object of the present invention to provide an apparatus and method of transmitting private information in a mobile terminal, which is capable of automatically solving a transfer data validity problem which may occur due to differences between specifications of hardwares supported for data transfer from an old mobile terminal to a new one.

### Technical Solution

To achieve the above objects, according to an aspect, the present invention provides a private information transfer apparatus for transferring data of a mobile terminal, comprising: a mobile terminal interface through which the mobile terminal accesses the private information transfer apparatus; a mobile terminal recognizer that recognizes the accessing mobile terminal; an authentication processor connected to an external authentication server for processing an authentication for the private information transfer apparatus; a mobile terminal module receiver connected to an external mobile terminal module provision server for requesting and receiving a mobile terminal module of the mobile terminal when the accessing mobile terminal is recognized; a storage that stores the data of the accessing mobile terminal according to the received mobile terminal module and provides the stored data at request; a controller connected to the mobile terminal interface, the mobile terminal recognizer, the authentication processor, the mobile terminal module receiver, and the storage for controlling data transfer of the mobile terminal.

According to another aspect, the present invention provides a private information transfer method for transferring data of a mobile terminal, comprising: a first step of recognizing a first connected mobile terminal to transmit private information of the first mobile terminal; a second step of performing an authentication process for private information transmission and receiving a result of the authentication process; a third step of receiving a mobile terminal module of the first mobile terminal recognized in the first step, and receiving and storing the private information from the first mobile terminal based on the result of the authentication process performed in the second step; a fourth step of recognizing a second mobile terminal connected to receive the stored private information; and a fifth step of receiving a mobile terminal module of the second mobile terminal recognized in the fourth step and transmitting the stored private information of the first mobile terminal to the second mobile terminal according to the received mobile terminal module of the second mobile terminal.

### Advantageous Effects

According to the present invention, the apparatus and method of transmitting private information in a mobile terminal is capable of receiving first data from an old mobile terminal when being requested to do so, converting the received first data into second data of a format adapted to a new mobile terminal, and transmitting the second data to the new mobile terminal.

In addition, according to the present invention, the apparatus and method of transmitting private information in a mobile terminal is capable of automatically solving a transfer data validity problem which may occur due to differences between specifications of hardwares supported for data transfer from an old mobile terminal to a new one.

### BRIEF DESCRIPTION OF THE DRAWINGS

FIG. 1 is a view showing a configuration of a private information transfer system of a mobile terminal according to an embodiment of the present invention.

FIG. 2 is a view showing a configuration of a private information transfer apparatus for transferring data of a mobile terminal according to an embodiment of the present invention.

FIG. 3 is a view showing a configuration of a storage having storing areas assigned depending on modules for a mobile terminal, in the private information transfer apparatus for transferring data of the mobile terminal according to the embodiment of the present invention.

FIG. 4 is a flow chart illustrating a private information transfer method of transferring data of a mobile terminal according to an embodiment of the present invention.

FIG. 5 is a detailed flow chart illustrating a provisioning process in the private information transfer method of transferring data of the mobile terminal according to the embodiment of the present invention.

### MODE FOR THE INVENTION

Hereinafter, preferred embodiments of the present invention will be described in detail with reference to the accompanying drawings. In the following detailed description of the present invention, concrete description on related functions and/or constructions will be omitted if it is deemed that the functions and/or constructions may unnecessarily obscure the gist of the present invention.

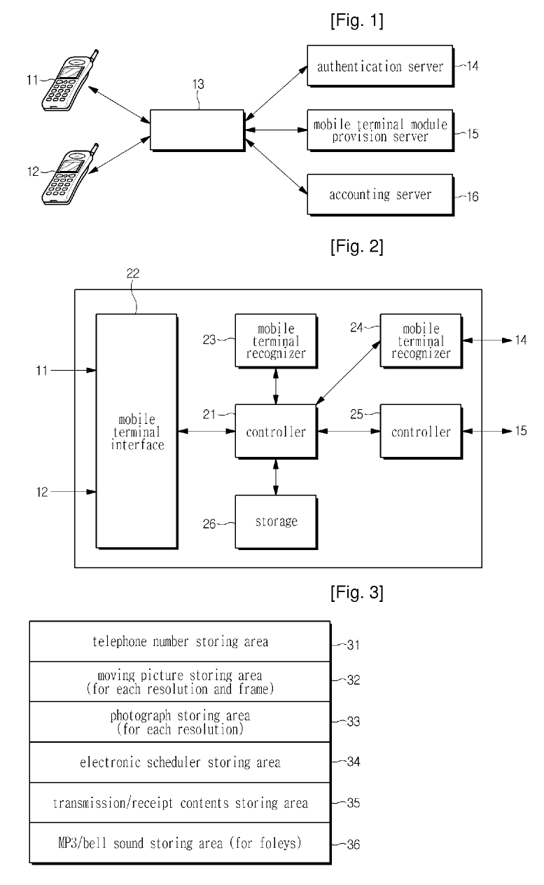

FIG. 1 is a view showing a configuration of a private information transfer system of a mobile terminal according to an embodiment of the present invention.

Referring to FIG. 1, a private information transfer system of the present invention includes a first mobile terminal 11 to transmit data stored therein, a second mobile terminal 12 to receive the data from the first mobile terminal 11, a private information transfer apparatus 13 that transfers the data from the first mobile terminal 11 to the second mobile terminal 12, an authentication server 14 that performs an authentication for the private information transfer apparatus 13 for data transfer between the first and second mobile terminals 11 and 12, and a mobile terminal module provision server 15 that stores and provides mobile terminal modules having information on data structures of mobile terminals of manufacturers and data formats supported by the mobile terminals.

In addition, if the private information transfer apparatus 13 needs service accounting, the private information transfer system may further include an accounting server 16 that provides accounting information.

In operation, when the first mobile terminal 11 to transmit the stored data accesses the private information transfer apparatus 13, the private information transfer apparatus 13 recognizes the first mobile terminal 11 and is authenticated by the authentication server 14 for transmission of private information. Then, the private information transfer apparatus 13 receives a mobile terminal module of the first mobile terminal 11 from the mobile terminal module provision server 15 and receives and stores data from the first mobile terminal 11 according to the received mobile terminal module.

Next, when the second mobile terminal 12 to receive data accesses the private information transfer apparatus 13, the private information transfer apparatus 13 recognizes the second mobile terminal 12. Then, the private information transfer apparatus 13 receives a mobile terminal module of the second mobile terminal 12 from the mobile terminal module provision server 15 and transmits the data stored in the first mobile terminal 11 to the second mobile terminal 12 according to the received mobile terminal module of the second mobile terminal 12.

FIG. 2 is a view showing a configuration of the private information transfer apparatus for transferring data of the mobile terminal according to the embodiment of the present invention.

Referring to FIG. 2, the private information transfer apparatus 13 that transfers the data of the mobile terminal includes a mobile terminal interface 22 through which a mobile terminal accesses the private information transfer apparatus 13, a mobile terminal recognizer 23 that recognizes the accessing mobile terminal, an authentication processor 24 connected to the authentication server 14 for processing an authentication for the private information transfer apparatus 13, a mobile terminal module receiver 25 connected to the mobile terminal module provision server 15 for requesting and receiving a mobile terminal module when the accessing mobile terminal is recognized, a storage 26 that stores and provides data of the accessing mobile terminal according to the received mobile terminal module, and a controller 21 that is connected to the above-mentioned components for controlling data transfer of the mobile terminal.

In operation, the mobile terminal interface 22 means a USB connector that is compatible with an external connector of the mobile terminal. Although the mobile terminal interface 22 is illustrated to have a single connector in this embodiment, it may have a plurality of connectors through which the private information transfer apparatus is connected to both of the first mobile terminal 11 and the second mobile terminal 12 for data transfer therebetween.

The mobile terminal recognizer 23 receives initial connection information of the mobile terminal, which is connected through the mobile terminal interface 22, from the controller 21, and recognizes the mobile terminal based on the received initial connection information and provides recognition information to the controller 21. Here, the recognition information is used to request the mobile terminal module.

The authentication processor 24 performs an authentication process to determine whether or not the private information transfer apparatus is qualified to process private information through the authentication server 14 under control of the controller 21. If not authenticated, the private information transfer apparatus 13 can not request and receive the private information from the connected mobile terminals 11 and 12.

The mobile terminal module receiver 25 receives the recognition information of the recognized mobile terminal from the controller 21, transmits the received recognition information to the mobile terminal module provision server 15, receives a mobile terminal module from the mobile terminal module provision server 15, and transmits the received mobile terminal module to the controller 21.

The storage 26 stores the private information temporarily for transmission of the private information. The storage 26 assigns storing areas according to the mobile terminal module transmitted from the controller 21 and stores the private information of the mobile terminal 11 transmitted from the controller 21 in the assigned storing areas.

When the mobile terminal 11 to transmit the private information is connected to the mobile terminal interface 22 of the private information transfer apparatus, the controller 21 transmits connection information to the mobile terminal recognizer 23 and receives the recognition information of the mobile terminal from the mobile terminal recognizer 23. Then, the controller 21 controls the authentication processor 24 to perform the authentication process for private information transmission, and receives a result of the authentication process from the authentication processor 24. Then, the controller 21 transmits the received recognition information to the mobile terminal module receiver 25, receives a mobile terminal module from the mobile terminal module receiver 25, and assigns the storing areas in the storage 26. Then, the controller 21 receives the private information from the mobile terminal through the recognition information and stores the received private information in the assigned storing areas of the storage 26. In addition, when the mobile terminal 12 to receive the stored private information is connected to the mobile terminal interface 22 of the private information transfer apparatus, the controller 21 transmits connection information to the mobile terminal recognizer 23 and receives the recognition information of the mobile terminal 12 from the mobile terminal recognizer 23. Then, the controller 21 transmits the received recognition information to the mobile terminal module receiver 25, receives a mobile terminal module from the mobile terminal module receiver 25, and provides data stored in the assigned storing areas of the storage 26 to the connected mobile terminal 12 according to the mobile terminal module. In addition, the controller 21 performs a provisioning process for comparing the mobile terminal module of the mobile terminal 11 to transmit the private information with the mobile terminal module of the mobile terminal 12 to receive the private information and changing a data format based on a result of the comparison.

FIG. 3 is a view showing a configuration of a storage having storing areas assigned depending on modules for a mobile terminal, in the private information transfer apparatus for transferring data of the mobile terminal according to the embodiment of the present invention.

Referring to in the private information transfer apparatus for transferring data of the mobile terminal, the storage 26 having the storing areas assigned according to the mobile terminal module includes a telephone number storing area 31 that stores a telephone directory, an address book, etc., a moving picture storing area 32 that stores moving pictures classified according to resolution (including downloaded moving pictures if there is no copyright problem), a photograph storing area 33 that stores photographs classified according to resolution (including downloaded photographs if there is no copyright problem), an electronic scheduler storing area 34 that stores promises, memos, anniversaries, etc., a transmission/receipt contents storing area 35 that stores call contents, SMS messages, etc., and an MP3/bell sound storing area 36 that stores downloaded bell sound and MP3 data.

These storing areas of the storage 26 are classified depending on the mobile terminal module. If the mobile terminal module does not provide the moving picture storing area 32, for example, this area 32 may be omitted.

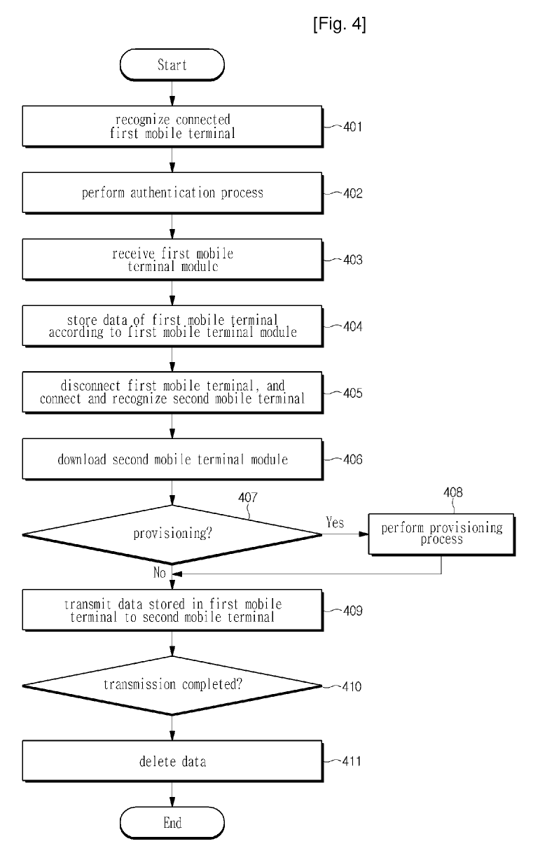

FIG. 4 is a flow chart illustrating a private information transfer method of transferring data of a mobile terminal according to an embodiment of the present invention.

Referring to FIG. 4, first, the private information transfer apparatus recognizes a first mobile terminal to transmit private information of the first mobile terminal connected thereto (Step 401).

Next, an authentication process for private information transmission is performed and a result of the authentication process is received (Step 402).

Next, a mobile terminal module of the recognized first mobile terminal is received using recognition information of the first mobile terminal (Step 403), and the private information is received from the first mobile terminal based on the result of the authentication process and is stored according to the received mobile terminal module (Step 404).

Next, the private information transfer apparatus is disconnected from the first mobile terminal, and is connected to a second mobile terminal to receive the stored private information and recognizes the second mobile terminal (Step 405).

Next, a mobile terminal module of the recognized second mobile terminal is received using recognition information of the second mobile terminal (Step 406).

Next, it is checked whether or not a provisioning process needs to be performed based on information on the mobile terminal modules of the first and second mobile terminals (Step 407).

If it is checked that the provisioning process does not need to be performed, the stored private information of the first mobile terminal is transmitted to the second mobile terminal (Step 409).

If it is checked that the provisioning process needs to be performed, the provisioning process is performed (Step 408), and then, the stored private information of the first mobile terminal is transmitted to the second mobile terminal (Step 409).

Finally, when the data transmission is completed (Step 410), the data stored in the private information transfer apparatus 13 is deleted (Step 411).

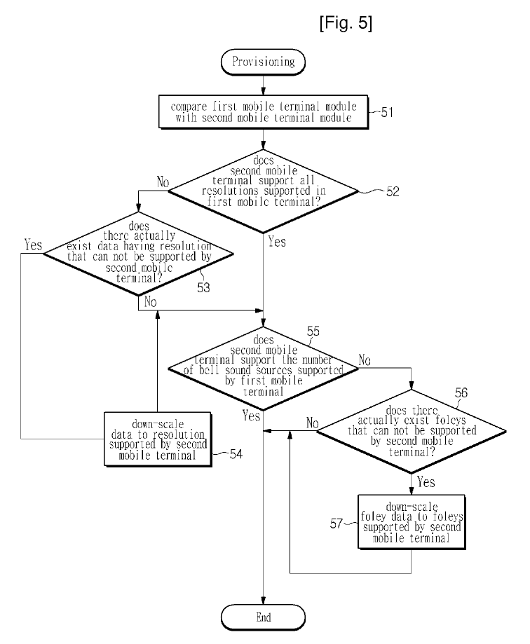

FIG. 5 is a detailed flow chart illustrating the provisioning process in the private information transfer method of transferring data of the mobile terminal according to the embodiment of the present invention.

In particular, FIG. 5 shows details of Steps 407 and 408 of FIG. 4.

Referring to FIG. 5, first, the mobile terminal module of the first mobile terminal to transmit the private information is compared with the mobile terminal module of the second mobile terminal to receive the private information (Step 51).

Based on a result of the comparison, it is checked whether or not the second mobile terminal supports all resolutions supported in the first mobile terminal (Step 52). In this case, all supportable resolution, not only the highest resolution, has to be checked. For example, assuming that the first mobile terminal supports resolutions of 640?480, 800?600, 1024?768 and 1600?1200 and the second mobile terminal supports resolutions of 640?480, 1024?768 and 1600?1200, a provisioning process needs to be performed for data having resolution of 800?600.

If it is checked that the second mobile terminal can not support all resolutions supported in the first mobile terminal, it is checked whether or not there actually exist data having resolution that can not be supported by the second mobile terminal (Step 53). If it is checked that there exist no data having resolution that can not be supported by the second mobile terminal, there is no need to perform the provisioning process.

On the contrary, if it is checked that there exist any data having resolution that can not be supported by the second mobile terminal, the data having the resolution (for example, 800?600) is down-scaled to a resolution supported by the second mobile terminal (for example, the resolution of 640?480 closest to the resolution of 800?600) (Step 54).

Considering a provisioning process for bell sound sources, it is checked whether or not the second mobile terminal supports the number of bell sound sources (for example, 40 foleys) supported by the first mobile terminal (Step 55).

If it is checked that the second mobile terminal does not support the number of bell sound sources supported by the first mobile terminal, it is checked whether or not there actually exist foleys that can not be supported by the second mobile terminal (Step 56). If it is checked that there exist foleys that can not be supported by the second mobile terminal, the foleys (for example, 40 foleys) are down-scaled to foleys supported by the second mobile terminal (for example, 16 foleys) (Step 57).

The private information transfer method as described above may be embodied by a program which can be recorded in a computer-readable recording medium (for example, a CD-ROM, a floppy disk, a hard disk, a magneto-optical disk, etc.)

While the present invention has been particularly shown and described with reference to exemplary embodiments thereof, it will be understood by those skilled in the art that various changes in form and details may be made therein without departing from the spirit and scope of the present invention as defined by the appended claims and equivalents thereof.

1. A private information transfer apparatus for transferring data of a mobile terminal, comprising:
a mobile terminal interface through which the mobile terminal accesses the private information transfer apparatus;
a mobile terminal recognizer that recognizes the accessing mobile terminal;
an authentication processor connected to an external authentication server for processing an authentication for the private information transfer apparatus;
a mobile terminal module receiver connected to an external mobile terminal module provision server for requesting and receiving a mobile terminal module of the mobile terminal when the accessing mobile terminal is recognized;
a storage that stores the data of the accessing mobile terminal according to the received mobile terminal module and provides the stored data at request;
a controller connected to the mobile terminal interface, the mobile terminal recognizer, the authentication processor, the mobile terminal module receiver, and the storage for controlling data transfer of the mobile terminal.

2. The private information transfer apparatus according to claim 1, wherein the mobile terminal interface comprises a USB connector that is compatible with an external connector of the mobile terminal.

3. The private information transfer apparatus according to claim 1, wherein the mobile terminal recognizer receives initial connection information of the mobile terminal, which is connected through the mobile terminal interface, from the controller, and recognizes the mobile terminal based on the received initial connection information and provides recognition information to the controller.

4. The private information transfer apparatus according to claim 1, wherein the storage stores the private information temporarily for transmission of the private information.

5. The private information transfer apparatus according to claim 4, wherein the storage assigns storing areas according to the mobile terminal module transmitted from the controller and stores the private information of the mobile terminal transmitted from the controller 21 in the assigned storing areas.

6. The private information transfer apparatus according to claim 1, wherein, when a first mobile terminal to transmit private information is connected to the mobile terminal interface, the controller:
transmits connection information of the first mobile terminal to the mobile terminal recognizer and receives recognition information of the first mobile terminal from the mobile terminal recognizer;
controls the authentication processor to perform the authentication process for private information transmission and receives a result of the authentication process from the authentication processor; and
transmits the received recognition information to the mobile terminal module receiver, receives a mobile terminal module of the first mobile terminal from the mobile terminal module receiver, assigns the storing areas in the storage,
receives the private information from the first mobile terminal through the recognition information, and stores the received private information in the assigned storing areas of the storage, and
when a second mobile terminal to receive the stored private information is connected to the mobile terminal interface, the controller:
transmits connection information of the second mobile terminal to the mobile terminal recognizer and receives recognition information of the second mobile terminal from the mobile terminal recognizer; and
transmits the received recognition information to the mobile terminal module receiver, receives a mobile terminal module of the second mobile terminal from the mobile terminal module receiver, and provides data stored in the assigned storing areas of the storage to the connected second mobile terminal according to the mobile terminal module of the second mobile terminal.

7. The private information transfer apparatus according to claim 6, wherein the controller performs a provisioning process for comparing the mobile terminal module of the first mobile terminal with the mobile terminal module of the second mobile terminal and changing a data format based on resolution and the number of sound sources, which are supported by the second mobile terminal.

8. A private information transfer method for transferring data of a mobile terminal, comprising:
a first step of recognizing a first connected mobile terminal to transmit private information of the first mobile terminal;
a second step of performing an authentication process for private information transmission and receiving a result of the authentication process;
a third step of receiving a mobile terminal module of the first mobile terminal recognized in the first step, and receiving and storing the private information from the first mobile terminal based on the result of the authentication process performed in the second step;
a fourth step of recognizing a second mobile terminal connected to receive the stored private information; and
a fifth step of receiving a mobile terminal module of the second mobile terminal recognized in the fourth step and transmitting the stored private information of the first mobile terminal to the second mobile terminal according to the received mobile terminal module of the second mobile terminal.

9. The private information transfer method according to claim 8, wherein the fifth step further comprises performing a provisioning process for comparing the mobile terminal module of the first mobile terminal with the mobile terminal module of the second mobile terminal and changing a data format based on a result of the comparison.

10. The private information transfer method according to claim 9, wherein the provisioning process comprises:
a sixth step of comparing the mobile terminal module of the first mobile terminal with the mobile terminal module of the second mobile terminal;
a seventh step of checking whether the second mobile terminal supports all resolutions supported in the first mobile terminal, based on a result of the comparison in the sixth step;
if it is checked at the seventh step that the second mobile terminal can not support all resolutions supported in the first mobile terminal, an eighth step of checking whether there actually exist data having resolution that can not be supported by the second mobile terminal;
if it is checked at the eighth step that there exist any data having resolution that can not be supported by the second mobile terminal, a ninth step of down-scaling the data having the resolution to a resolution supported by the second mobile terminal;
a tenth step of checking whether the second mobile terminal supports the number of bell sound sources supported by the first mobile terminal; and
if it is checked at the tenth step that the second mobile terminal does not support the number of bell sound sources supported by the first mobile terminal, an eleventh step of checking whether there actually exist foleys that can not be supported by the second mobile terminal, and if it is checked that there exist foleys that can not be supported by the second mobile terminal, down-scaling the foleys to foleys supported by the second mobile terminal.
